(19) United States
(12) Patent Application Publication
(10) Pub. No.: US 2014/0329529 A1
(43) Pub. Date: Nov. 6, 2014

(54) METHOD OF CELL RESELECTION BY APPLYING SUPREME PRIORITY IN WIRELESS COMMUNICATION SYSTEM AND APPARATUS FOR THE SAME

(71) Applicant: LG ELECTRONICS INC., Seoul (KR)

(72) Inventors: Sung Hoon Jung, Anyang-si (KR); Seung June Yi, Anyang-si (KR); Young Dae Lee, Anyang-si (KR); Sung Jun Park, Anyang-si (KR)

(73) Assignee: LG ELECTRONICS INC., Seoul (KR)

(21) Appl. No.: 14/351,016

(22) PCT Filed: Nov. 5, 2012
(86) PCT No.: PCT/KR2012/009221

§ 371 Date: Apr. 10, 2014

Related U.S. Application Data
(60) Provisional application No. 61/555,480, filed on Nov. 4, 2011.
(60) Provisional application No. 61/638,503, filed on Apr. 26, 2012.

(51) Int. Cl. H04W 36/16

(52) U.S. Cl. CPC H04W 36/16
USPC 455/436

(57) ABSTRACT

A method of a cell reselection performed by a user equipment (UE) in a wireless communication system, the method comprising: receiving supreme priority information from a target cell, the supreme priority information indicating whether a deprioritization is applied; applying the supreme priority information, if the supreme priority information indicates that the deprioritization is applied; and performing a cell reselection based on the applied deprioritization.

### TECHNICAL FIELD

The present invention relates to a wireless communication, more particularly, to a method of a cell reselection by applying a supreme priority in a wireless communication system and an apparatus for the same.

### BACKGROUND ART

3^{rd} generation partnership project (3GPP) long term evolution (LTE) is an improved version of a universal mobile telecommunication system (UMTS) and is introduced as the 3GPP release 8. The 3GPP LTE uses orthogonal frequency division multiple access (OFDMA) in a downlink, and uses single carrier-frequency division multiple access (SC-FDMA) in an uplink. The 3GPP LTE employs multiple input multiple output (MIMO) having up to four antennas. In recent years, there is an ongoing discussion on 3GPP LTE-advanced (LTE-A) that is an evolution of the 3GPP LTE.

A micro cell, a femto cell, and a pico cell, etc., having a small service area can be installed in a specific location of a macro cell having a wide coverage.

Due to mobility of a user equipment (UE) represented as a mobile device, quality of a currently provided service may deteriorate or a cell capable of providing a better service may be detected. Accordingly, the UE may move to a new cell, which is called performing of the mobility of the UE.

In a procedure for a cell reselection, a UE selects a target cell based on priorities of frequencies. And then, the UE tries to connect to the target cell by transmitting connection requesting message. When the connection to the target cell completes, the UE can receive a service from the target cell.

In a certain case, the request of the UE may be rejected for various reasons, e.g. an overload of the target cell. Then, the UE performs the cell reselection procedure again based on the priorities. The UE may select the cell, which rejected the request of the UE, as a new target cell, and the cell is still in a situation where the cell cannot provide a normal service. As a result, the UE repeatedly performs the cell reselection, but cannot receive any service from a network. Therefore, some mechanism to allow network to control the cell reselection operation of UE is needed in case the request for connection is rejected.

### SUMMARY OF INVENTION

### Technical Problem

The present invention provides a method of a cell reselection by applying a supreme priority in a wireless communication system and an apparatus for the same.

### Solution to Problem

In an aspect, a method of a cell reselection performed by a user equipment (UE) in a wireless communication system, the method comprising: receiving supreme priority information from a target cell, the supreme priority information indicating whether a deprioritization is applied; applying the supreme priority information, if the supreme priority information indicates that the deprioritization is applied; and performing a cell reselection based on the applied deprioritization.

The supreme priority information may be transmitted in an RRC connection reject message

The step of applying the supreme priority may include deprioritizing a priority of a frequency of the target cell by considering the frequency to be the lowest priority frequency.

The step of applying the supreme priority may include: deprioritizing priorities of all frequencies of a Radio Access Technology of the target cell by considering the frequencies to be the lowest priority frequency.

The RRC connection reject message further may include timer information indicating a time duration for which the deprioritization is applied.

The method may further include starting a timer set to the time duration indicated by the timer information.

The method may further include canceling the deprioritization when the timer is expired.

The method may further include receiving an RRC connection reject message from other target cell, the RRC connection reject message comprising the timer information, and restarting the timer.

The method may further include establishing an RRC connection with a cell. The started timer may keep operating after the establishment until the end of the time duration.

The method may further include entering an RRC connected state. The started timer may keep operating after the entry of the UE until the end of the time duration.

In another aspect, a wireless apparatus in a wireless communication system is provided. The wireless apparatus includes Radio Frequency (RF) unit transmitting and receiving radio signals; and a processor operably coupled to the RF unit. The processor is configured for: receiving supreme priority information from a target cell, the supreme priority information indicating whether a deprioritization is applied, applying the supreme priority information, if the supreme priority information indicates that the deprioritization is applied, and performing a cell reselection based on the applied deprioritization.

### Advantageous Effects of Invention

According to the present invention, the application of supreme priority information to a frequency of certain cell or all frequencies of a certain RAT to which a UE is not allowed to connect prevents the UE from repeatedly performing a cell reselection and/or an RRC connection establishment procedure with the same cell which has rejected a request of the UE. The UE can select a proper target cell by applying the supreme priority and quickly establish an RRC connection with the target cell. Therefore, a quality of service provided to the UE can be enhanced.

According to the present invention, a timer for the supreme priority information is provided. During the operation of the timer, the UE applies the supreme priority information. The operation of the timer prevents the UE from returning to the cell which reject a request of the UE after the cell reselection procedure. Therefore, by using the timer, a stable service for the UE can be provided.

### BRIEF DESCRIPTION OF DRAWINGS

FIG. 1 illustrates a wireless communication system to which the present invention is applied.

FIG. 2 is a diagram illustrating a radio protocol architecture for a user plane.

FIG. 3 is a diagram illustrating a radio protocol architecture for a control plane.

FIG. 4 is a flow chart illustrating an operation of a UE in an RRC idle state.

FIG. 5 is a flowchart showing an RRC connection establishment procedure.

FIG. 6 is a flowchart showing an RRC connection reconfiguration procedure.

FIG. 7 is a flow chart illustrating an RRC connection re-establishment procedure.

FIG. 8 is a flowchart showing a conventional method of performing measurement.

FIG. 9 shows an example of a measurement configuration assigned to a UE.

FIG. 10 shows an example of deleting a measurement identity.

FIG. 11 shows an example of deleting a measurement object.

FIG. 12 is a flow chart showing an example of a method of a cell reselection by applying supreme priority according to an embodiment of the present invention.

FIG. 13 is a flow chart showing another example of a method of a cell reselection by applying supreme priority according to an embodiment of the present invention.

FIG. 14 is a block diagram showing a wireless apparatus according to an embodiment of the present invention.

### MODE FOR THE INVENTION

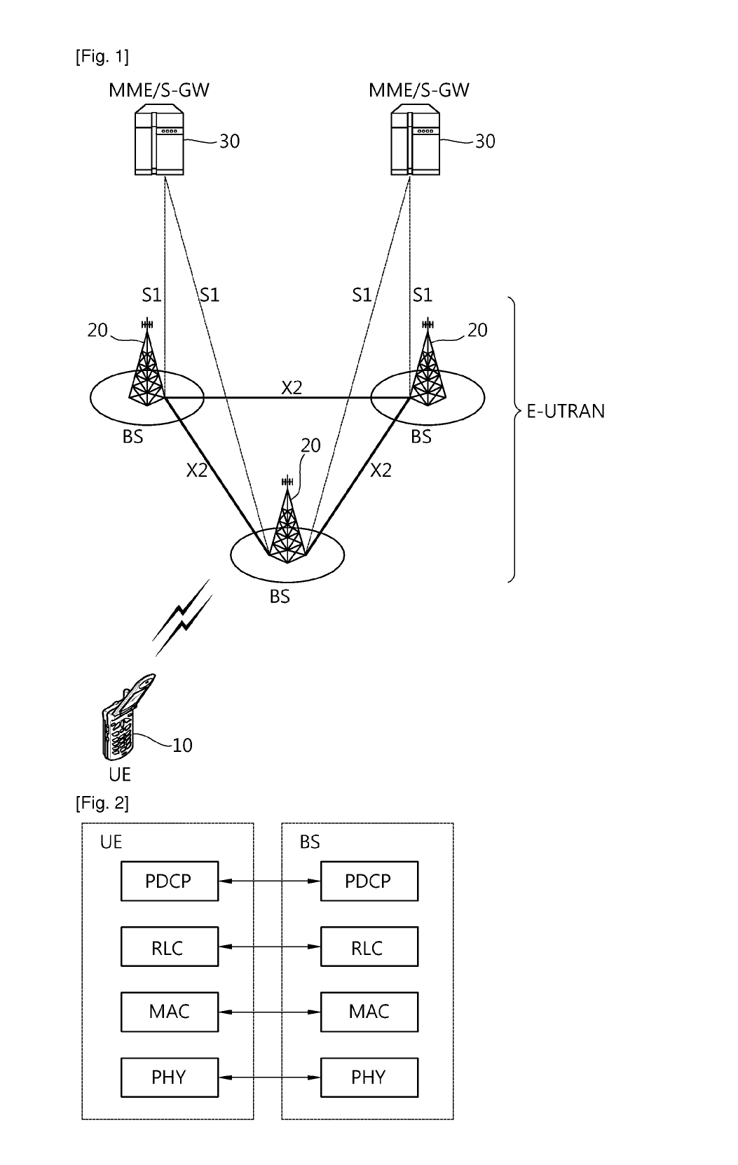

FIG. 1 illustrates a wireless communication system to which the present invention is applied. The wireless communication system may also be referred to as an evolved-UMTS terrestrial radio access network (E-UTRAN) or a long term evolution (LTE)/LTE-A system.

The E-UTRAN includes at least one base station (BS) 20 which provides a control plane and a user plane to a user equipment (UE) 10. The UE 10 may be fixed or mobile, and may be referred to as another terminology, such as a mobile station (MS), a user terminal (UT), a subscriber station (SS), a mobile terminal (MT), a wireless device, etc. The BS 20 is generally a fixed station that communicates with the UE 10 and may be referred to as another terminology, such as an evolved node-B (eNB), a base transceiver system (BTS), an access point, etc.

The BSs 20 are interconnected by means of an X2 interface. The BSs 20 are also connected by means of an S1 interface to an evolved packet core (EPC) 30, more specifically, to a mobility management entity (MME) through S1-MME and to a serving gateway (S-GW) through S1-U.

The EPC 30 includes an MME, an S-GW, and a packet data network-gateway (P-GW). The MME has access information of the UE or capability information of the UE, and such information is generally used for mobility management of the UE. The S-GW is a gateway having an E-UTRAN as an end point. The P-GW is a gateway having a PDN as an end point.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

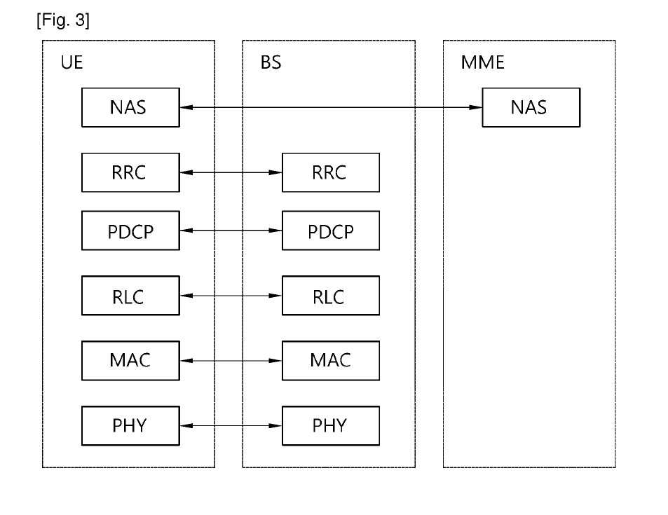

FIG. 2 is a diagram illustrating a radio protocol architecture for a user plane. FIG. 3 is a diagram illustrating a radio protocol architecture for a control plane. The user plane is a protocol stack for user data transmission. The control plane is a protocol stack for control signal transmission.

Referring to FIGS. 2 and 3, a PHY layer provides an upper layer with an information transfer service through a physical channel. The PHY layer is connected to a medium access control (MAC) layer which is an upper layer of the PHY layer through a transport channel. Data is transferred between the MAC layer and the PHY layer through the transport channel. The transport channel is classified according to how and with what characteristics data is transmitted through a radio interface.

Between different PHY layers, i.e., a PHY layer of a transmitter and a PHY layer of a receiver, data are transferred through the physical channel. The physical channel is modulated using an orthogonal frequency division multiplexing (OFDM) scheme, and utilizes time and frequency as a radio resource.

A function of the MAC layer includes mapping between a logical channel and a transport channel and multiplexing/de-multiplexing on a transport block provided to a physical channel over a transport channel of a MAC service data unit (SDU) belonging to the logical channel. The MAC layer provides a service to a radio link control (RLC) layer through the logical channel.

A function of the RLC layer includes RLC SDU concatenation, segmentation, and re-assembly. To ensure a variety of quality of service (QoS) required by a radio bearer (RB), the RLC layer provides three operation modes, i.e., a transparent mode (TM), an unacknowledged mode (UM), and an acknowledged mode (AM). The AM RLC provides error correction by using an automatic repeat request (ARQ).

Functions of a packet data convergence protocol (PDCP) layer in the user plane include user data delivery, header compression, and ciphering. Functions of a PDCP layer in the control plane include control-plane data delivery and ciphering/integrity protection.

A radio resource control (RRC) layer is defined only in the control plane. The RRC layer serves to control the logical channel, the transport channel, and the physical channel in association with configuration, reconfiguration and release of radio bearers (RBs). An RB is a logical path provided by the first layer (i.e., PHY layer) and the second layer (i.e., MAC layer, RLC layer, and PDCP layer) for data delivery between the UE and the network.

The configuration of the RB implies a process for specifying a radio protocol layer and channel properties to provide a specific service and for determining respective detailed parameters and operations. The RB can be classified into two types, i.e., a signaling RB (SRB) and a data RB (DRB). The SRB is used as a path for transmitting an RRC message in the control plane. The DRB is used as a path for transmitting user data in the user plane.

When an RRC connection exists between an RRC layer of the UE and an RRC layer of the network, the UE is in an RRC connected state, and otherwise the UE is in an RRC idle state.

Data are transmitted from the network to the UE through a downlink transport channel. Examples of the downlink transport channel include a broadcast channel (BCH) for transmitting system information and a downlink-shared channel (SCH) for transmitting user traffic or control messages. The user traffic of downlink multicast or broadcast services or the control messages can be transmitted on the downlink-SCH or an additional downlink multicast channel (MCH). Data are transmitted from the UE to the network through an uplink transport channel. Examples of the uplink transport channel include a random access channel (RACH) for transmitting an initial control message and an uplink SCH for transmitting user traffic or control messages.

Examples of logical channels belonging to a higher channel of the transport channel and mapped onto the transport channels include a broadcast channel (BCCH), a paging control channel (PCCH), a common control channel (CCCH), a multicast control channel (MCCH), a multicast traffic channel (MTCH), etc.

The physical channel includes several symbols in a time domain and several sub-carriers in a frequency domain. One sub-frame includes a plurality of symbols in the time domain. One subframe includes a plurality of resource blocks. One resource block includes a plurality of symbols and a plurality of sub-carriers. Further, each subframe may use specific sub-carriers of specific symbols (e.g., a first symbol) of a corresponding subframe for a physical downlink control channel (PDCCH), i.e., an L1/L2 control channel. A transmission time interval (TTI) is a unit time of data transmission, and is 1 millisecond (ms) which corresponds to one subframe.

Hereinafter, an RRC state of a UE and an RRC connection will be disclosed.

The RRC state indicates whether an RRC layer of the UE is logically connected to an RRC layer of an E-UTRAN. If the two layers are connected to each other, it is called an RRC connected state, and if the two layers are not connected to each other, it is called an RRC idle state. When in the RRC connected state, the UE has an RRC connection and thus the E-UTRAN can recognize a presence of the UE in a cell unit. Accordingly, the UE can be effectively controlled. On the other hand, when in the RRC idle state, the UE cannot be recognized by the E-UTRAN, and is managed by a core network in a tracking area unit which is a unit of a wider area than a cell. That is, regarding the UE in the RRC idle state, only a presence or absence of the UE is recognized in a wide area unit. To get a typical mobile communication service such as voice or data, a transition to the RRC connected state is necessary.

When a user initially powers on the UE, the UE first searches for a proper cell and thereafter stays in the RRC idle state in the cell. Only when there is a need to establish an RRC connection, the UE staying in the RRC idle state establishes the RRC connection with the E-UTRAN through an RRC connection procedure and then transitions to the RRC connected state. Examples of a case where the UE in the RRC idle state needs to establish the RRC connection are various, such as a case where uplink data transmission is necessary due to telephony attempt of the user or the like or a case where a response message is transmitted in response to a paging message received from the E-UTRAN.

A non-access stratum (NAS) layer belongs to an upper layer of the RRC layer and serves to perform session management, mobility management, or the like.

To manage mobility of the UE in the NAS layer, two states are defined, i.e., an EPS mobility management-REGISTERED (EMM-REGISTERED) state and an EMM-DEREGISTERED state. These two states apply to the UE and the MME. Initially, the UE is in the EMM-DEREGISTERED state. To access a network, the UE performs a procedure of registering to the network through an initial attach procedure. If the attach procedure is successfully completed, the UE and the MME enter the EMM-REGISTERED state.

To manage a signaling connection between the UE and the EPC, two states are defined, i.e., an EPS connection management (ECM)-IDLE state and an ECM-CONNECTED state. These two states apply to the UE and the MME. When a UE in the ECM-IDLE state establishes an RRC connection with the E-UTRAN, the UE enters the ECM-CONNECTED state. When an MME in the ECM-IDLE state establishes an S1 connection with the E-UTRAN, the MME enters the ECM-CONNECTED state. When the UE is in the ECM-IDLE state, the E-UTRAN does not have context information of the UE. Therefore, the UE in the ECM-IDLE state performs a UE-based mobility related procedure such as cell selection or reselection without having to receive a command of the network. On the other hand, when the UE is in the ECM-CONNECTED state, mobility of the UE is managed by the command of the network. If a location of the UE in the ECM-IDLE state becomes different from a location known to the network, the UE reports the location of the UE to the network through a tracking area update procedure.

Next, system information will be disclosed.

The system information includes essential information that needs to be known to a UE to access a BS. Thus, the UE has to receive all system information before accessing the BS. Further, the UE always has to have the latest system information. Since the system information is information that must be known to all UEs in one cell, the BS periodically transmits the system information.

According to the section 5.2.2 of 3GPP TS 36.331 V8.7.0 (2009-09) “Radio Resource Control (RRC); Protocol specification (Release 8)”, the system information is classified into a master information block (MIB), a scheduled block (SB), and a system information block (SIB). The MIB allows the UE to know a physical configuration (e.g., bandwidth) of a specific cell. The SB reports transmission information (e.g., a transmission period or the like) of SIBs. The SIB is a group of a plurality of pieces of system information related to each other. For example, an SIB includes only information of a neighboring cell, and another SIB includes only information of an uplink radio channel used by the UE.

In general, a service provided by the network to the UE can be classified into three types to be described below. Further, according to which service can be provided, the UE recognizes a cell type differently. A service type will be first described below, and then the cell type will be described.

1) Limited service: This service provides an emergency call and an earthquake and tsunami warning system (ETWS), and can be provided in an acceptable cell.

2) Normal service: This service denotes a public use service for general use, and can be provided in a suitable or normal cell.

3) Operator service: This service denotes a service for a network service provider, and a cell can be used only by the network service provider and cannot be used by a normal user.

A service type provided by a cell can be identified as follows.

1) Acceptable cell: A UE can receive a limited service in this cell. This cell is not barred from the perspective of the UE, and satisfies a cell selection criterion of the UE.

2) Suitable cell: The UE can receive a regular service in this cell. This cell satisfies a condition of an acceptable cell, and also satisfies additional conditions. Regarding the additional conditions, this cell has to belong to a PLMN to which the UE can access, and a tracking area update procedure of the UE must not be barred in this cell. If a specific cell is a CSG cell, this cell must be accessible by the UE as a CSG member.

3) Barred cell: Information indicating that a cell is a barred cell is broadcast in this cell by using system information.

4) Reserved cell: Information indicating that a cell is a reserved cell is broadcast in this cell by using system information.

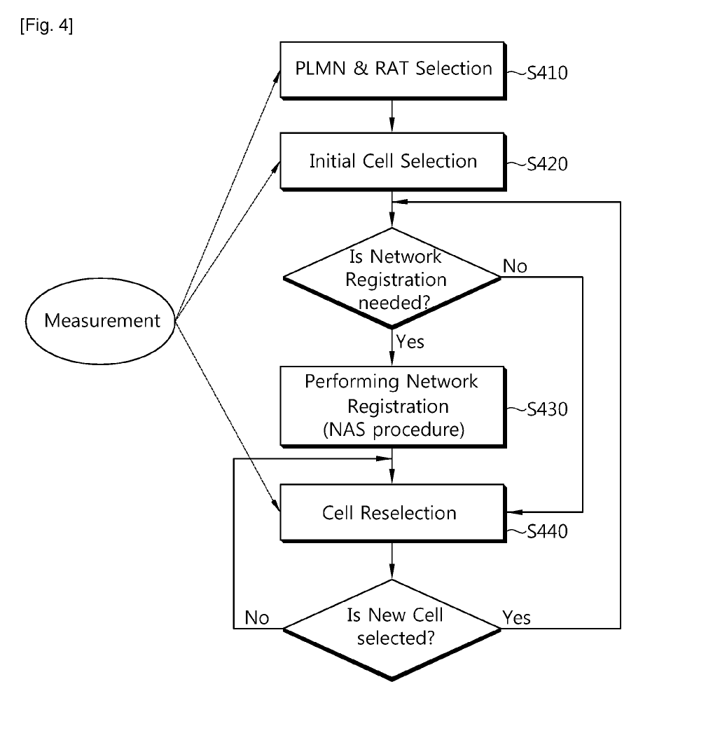

FIG. 4 is a flow chart illustrating an operation of a UE in an RRC idle state. Specifically, FIG. 4 shows a procedure in which a UE is registered to a network through a cell selection process when power of the UE is turned on, and a cell reselection is performed when necessary.

Referring to FIG. 4, the UE selects a radio access technology (RAT) for communicating with a PLMN (public land mobile network) as a network the UE wants to receive a service therefrom (S410). Information regarding the and RAT may be selected by a user of the UE, or that stored in a USIM (universal subscriber identity module) may be used.

The UE selects a cell having the greatest value among cells in which signal strength or quality thereof is greater than a particular value (S420). This is performed by a UE as power thereof is turned on, which may be called an initial cell selection. The cell selection procedure will be described later. After the cell selection, the UE receives system information periodically transmitted by a BS. The particular value refers to a value defined in the system in order to guarantee quality of a physical signal in data transmission and reception. Thus, it may vary according to an applied RAT.

When a network registration is required, the UE performs a network registration procedure (S430). In order to receive a service (e.g., paging) from the network, the UE registers its information (e.g., an IMSI). The UE is not registered to a network whenever a cell is selected, and registered to a network when information (e.g., tracking area identity (TAI) of a network received from the system information and information of a network the UE knows are different.

The UE performs cell re-selection based on a service environment provided in a cell, a terminal environment, or the like (S440). When signal strength or quality value measured from a BS serving the UE is lower than a value measured from a BS of an adjacent cell, the UE selects one of cells providing better signal characteristics than that of the cell of the BS the UE has accessed. This process is called a cell re-selection, discriminated from initial cell selection performed twice. Here, in order to prevent a cell is frequently re-selected according to a change in signal characteristics, a temporal constraint is provided. The cell re-selection procedure will be described later.

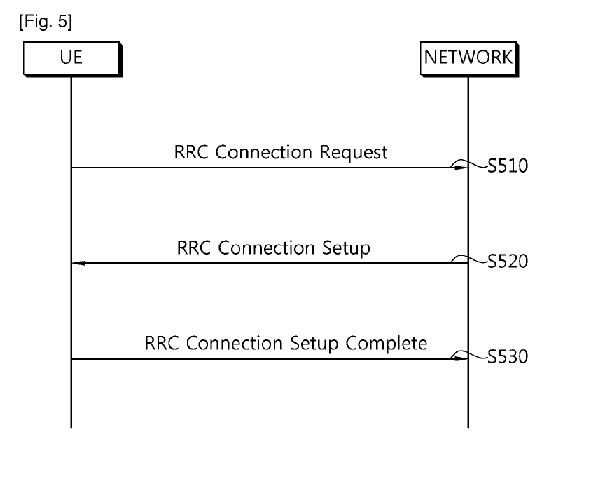

FIG. 5 is a flowchart showing an RRC connection establishment procedure.

A UE sends to a network an RRC connection request message for requesting an RRC connection (step S510). The network sends an RRC connection setup message in response to the RRC connection request (step S520). After receiving the RRC connection setup message, the UE enters an RRC connection mode.

The UE sends to the network an RRC connection setup complete message used to confirm successful completion of the RRC connection establishment (step S530).

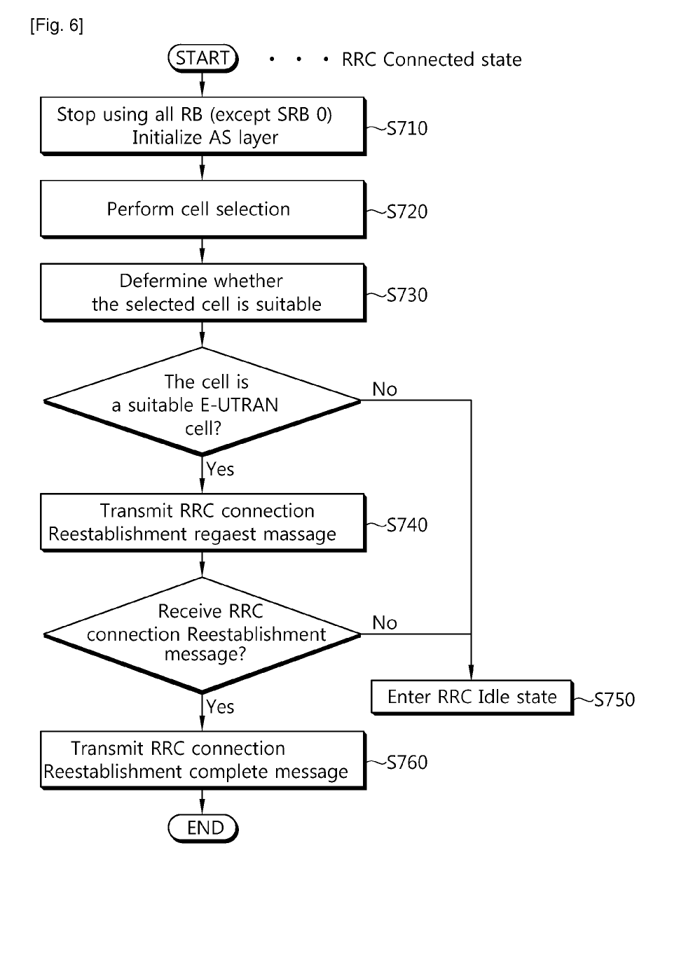

FIG. 6 is a flowchart showing an RRC connection reconfiguration procedure. An RRC connection reconfiguration is used to modify an RRC connection. This is used to establish/modify/release an RB, to perform a handover, and to set up/modify/release a measurement.

A network sends to a UE an RRC connection reconfiguration message for modifying the RRC connection (step S610). In response to the RRC connection reconfiguration, the UE sends to the network an RRC connection reconfiguration complete message used to confirm successful completion of the RRC connection reconfiguration (step S620).

Next, a procedure for selecting a cell by the UE will be described in detail.

If the UE is turned on or is camped on a cell, the UE may perform procedures for selecting/reselecting a cell having suitable quality in order to receive a service.

The UE in an RRC idle state needs to be ready to receive the service through the cell by selecting the cell having suitable quality all the time. For example, the UE that has been just turned on must select the cell having suitable quality so as to be registered into a network. If the UE that has stayed in an RRC connected state enters into the RRC idle state, the UE must select a cell on which the UE itself is camped. As such, a process of selecting a cell satisfying a certain condition by the UE in order to stay in a service waiting state such as the RRC idle state is called a cell selection. The cell selection is performed in a state that the UE does not currently determine a cell on which the UE itself is camped in the RRC idle state, and thus it is very important to select the cell as quickly as possible. Therefore, if a cell provides radio signal quality greater than or equal to a predetermined level, the cell may be selected in the cell selection process of the UE even though the cell is not a cell providing best radio signal quality.

Hereinafter, by referring to the 3GPP TS 36.304 V8.5.0 (2009-03) “User Equipment (UE) procedures in idle mode (Release 8)”, a method and procedure for selecting a cell by a UE in 3GPP LTE will be described in detail.

If power is initially turned on, the UE searches for available PLMNs and selects a suitable PLMN to receive a service. Subsequently, the UE selects a cell having a signal quality and property capable of receiving a suitable service among the cells provided by the selected PLMN.

The cell selection process can be classified into two processes.

One process is an initial cell selection process, and in this process, the UE does not have previous information on radio channels. Therefore, the UE searches for all radio channels to find a suitable cell. In each channel, the UE searches for the strongest cell. Subsequently, if a suitable cell satisfying cell selection criteria is found, the UE selects the cell.

After the UE selects a certain cell through a cell selection process, the signal strength and quality between the UE and the BS may be changed due to the change of the UE mobility and wireless environment. Therefore, if the quality of the selected cell deteriorates, the UE may select another cell providing better quality. If a cell is reselected in this manner, a cell providing signal quality better than that of the currently selected cell is selected in general. This process is called a cell reselection. A basic purpose of the cell reselection process is generally to select a cell providing best quality to the UE from the perspective of the radio signal quality.

In addition to the perspective of the radio signal quality, the network may notify the UE of a priority determined for each frequency. The UE that has received the priority may consider this priority more preferentially than the radio signal quality criteria during the cell reselection process.

As described above, there is a method of selecting or reselecting a cell based on the signal property of the wireless environment. When a cell is selected for reselection in the cell reselection process, there may be cell reselection methods as described below, based on the RAT and frequency characteristics of the cell.
Intra-frequency cell reselection: A reselected cell is a cell having the same center-frequency and the same RAT as those used in a cell on which the UE is currently being camped.
Inter-frequency cell reselection: A reselected cell is a cell having the same RAT and a different center-frequency with respect to those used in the cell on which the UE is currently being camped.
Inter-RAT cell reselection: A reselected cell is a cell using a different RAT from a RAT used in the cell on which the UE is currently being camped.

The principles of the cell reselection process are as follows.

First, the UE measures quality of a serving cell and a neighboring cell for a cell reselection.

Second, the cell reselection is performed based on cell reselection criteria. The cell reselection criteria have following characteristics with regard to the measurement of serving cells and neighboring cells.

The intra-frequency cell reselection is basically based on ranking. The ranking is an operation for defining a criterion value for evaluation of the cell reselection and for ordering cells according to a magnitude of the criterion value by using the criterion value. A cell having the highest criterion is referred to as a best-ranked cell. The cell criterion value is a value to which a frequency offset or a cell offset is optionally applied on the basis of a value measured by the UE for a corresponding cell.

The inter-frequency cell reselection is based on a frequency priority provided by the network. The UE attempts to be camped on a frequency having a highest priority. The network may provide the same frequency priority to be commonly applied to UEs in a cell by using broadcast signaling or may provide a frequency-specific priority to each UE by using dedicated signaling for each UE.

For the inter-frequency cell reselection, the network may provide parameters (e.g., frequency-specific offsets) for use in cell reselection to the UE for each frequency.

For the intra-frequency cell reselection or the inter-frequency cell reselection, the network may provide a neighboring cell list (NCL) for use in the cell reselection to the UE. The NCL includes cell-specific parameters (e.g. cell-specific offsets) used in the cell reselection.

For the intra-frequency or inter-frequency cell reselection, the network may provide the UE with a black list, i.e., a list of cells not to be selected in the cell reselection. The UE does not perform the cell reselection on cells included in the black list.

Now, the ranking used in a cell reselection evaluation process will be described.

A ranking criterion used to assign a priority to a cell is defined by Equation 1 below.

R_{S}=Q_{meas,s}+Q_{hyst}, Rₙ=Q_{meas,n}−Q_{offset} [Math. 1]

Herein, Rs denotes a ranking value of a serving cell, Rn denotes a ranking criterion of a neighboring cell, Qmeas,s denotes a quality value measured for the serving cell by the UE, Qmeas,n denotes a quality value measured for the neighboring cell by the UE, Qhyst denotes a hysteresis value for ranking, and Qoffset denotes an offset between two cells.

In the intra-frequency cell reselection, if the UE receives an offset Qoffsets,n between the serving cell and the neighboring cell, Qoffset=Qoffsets,n. Otherwise, Qoffset=0.

In the inter-frequency cell reselection, if the UE receives the offset Qoffsets,n, Qoffset=Qoffsets,n+Qfrequency. Otherwise, Qoffset=Qfrequency.

If the ranking criterion Rs of the serving cell and the ranking criterion Rn of the neighboring cell are not much different from each other and constantly vary, ranking orders of the serving cell and the neighboring cell may change frequently. Thus, the serving cell and the neighboring cell may be reselected alternately while changing their ranking orders frequently. In order to prevent the UE from reselecting two cells alternately, the hysteresis value Qhyst is used to give a hysteresis in the cell reselection.

The UE measures the ranking criterion Rs of the serving cell and the ranking criterion Rn of the neighboring cell according to the above equation. A cell having the greatest ranking criterion value is reselected by considering this cell as a best-ranked cell.

In the above-mentioned cell reselection criterion, the quality of cells is considered as a most important factor when performing the cell reselection. If a reselected cell is not a suitable cell, the UE excludes the reselected cell or a frequency of the reselected cell from targets of the cell reselection.

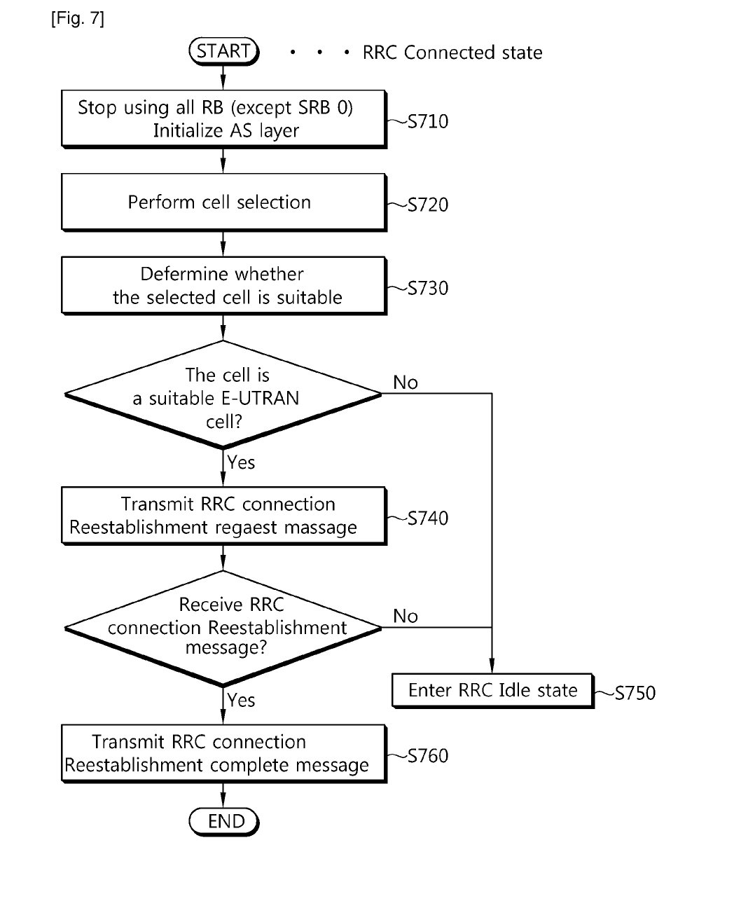

FIG. 7 is a flow chart illustrating an RRC connection re-establishment procedure.

Referring to FIG. 7, a UE stops using of all the set radio bearers excluding SRB0 (Signaling Radio Bearer #0), and initializes various sub-layers of an Access Stratum (AS) (S710). Also, the UE sets each sub-layer and physical layer as a default configuration. During this process, the UE is maintained in an RRC connected state.

The UE performs a cell selection procedure to perform an RRC connection re-establishment procedure (S720). Although the UE is maintained in the RRC connected state, the cell selection procedure included in the RRC connection re-establishment procedure may be performed in the same manner as the cell selection procedure performed by the UE in an RRC idle state.

After performing the cell selection procedure, the UE checks system information of a corresponding cell to determine whether or not the corresponding cell is an appropriate cell (S730). When the selected cell is determined to be an appropriate E-UTRAN cell, the UE transmits an RRC connection reestablishment request message to the corresponding cell (S740).

Meanwhile, when it is determined that the cell selected through the cell selection procedure to perform an RRC connection re-establishment procedure is a cell that uses a different RAT other than the E-UTRAN, the RRC connection re-establishment procedure is stopped and the UE enters an RRC idle state (S750).

The UE may be implemented to finish checking appropriateness of a cell within a limited time through the cell selection procedure and reception of system information of a selected cell. To this end, the UE may drive a timer when an RRC connection re-establishment procedure starts. The timer may be stopped when the UE determines that an appropriate cell has been selected. When the timer expires, the UE may determine that the RRC connection reestablishment procedure has failed and enters an RRC idle state. The timer will be referred to as a radio link failure timer hereinafter. In the LTE specification TS 36.331, a timer named T311 may be utilized as a radio link failure timer. The UE may obtain a set value of the timer from system information of a serving cell.

When the cell receives an RRC connection re-establishment request message from the UE and accepts the request, the cell transmits an RRC connection reestablishment message to the UE.

Upon receiving the RRC connection reestablishment message from the cell, the UE reconfigures a PDCP sublayer and an RLC sublayer with respect to an SRB1. Also, the UE re-calculates various key values in relation to security setting, and re-configures a PDCP sublayer responsible for security with newly calculated security key values. Through this, the SRB1 between the UE and the CELL is open, and an RRC control message may be exchanged. The UE completes resuming of the SRB1, and transmits an RRC connection reestablishment complete message indicating that the RRC connection reestablishment procedure was completed to the cell (S760).

Meanwhile, upon receiving the RRC connection reestablishment request message, if the cell does not accept the request, the cell transmits an RRC connection reestablishment reject message to the UE.

When the RRC connection reestablishment procedure is successfully performed, the cell and the terminal performs an RRC connection reestablishment procedure. Through this, the UE may recover the state before the RRC connection reestablishment procedure was performed and continuity of a service is guaranteed to its maximum level.

Not, a network registration will be described.

A Public Land Mobile Network (PLMN) is a network deployed and operated by mobile network operator(s). Each mobile network operator runs one or more PLMNs. Each PLMN can be identified with the Mobile Country Code (MCC) and the Mobile Network Code (MNC). The PLMN information of a cell is broadcast in the system information.

For PLMN selection, cell selection, and cell reselection, several types of PLMNs are considered by UE.

Home PLMN (HPLMN): The PLMN whose MCC and the MNC matches the MCC and the MNC of the UE's IMSI.

Equivalent HPLMN (EHPLMN): Any PLMN that is equivalent to HPLMN.

Registered PLMN (RPLMN): The PLMN for which location registration is successful.

Equivalent PLMN (EPLMN): Any PLMN that is equivalent to RPLMN.

Each mobile service subscriber has a subscription with a HPLMN. When the normal service is provided to UE by the HPLMN or the EHPLMN, the UE is not in a roaming state. On the other hand, when the service is provided to UE by the PLMN other than HPLMN/EPHPLN, the UE is in a roaming state, and the PLMN is called Visited PLMN (VPLMN).

When UE is powered on, PLMN selection is triggered. For the selected PLMN, UE attempts to register the selected PLMN. If the registration is successful, the selected PLMN becomes RPLMN. Network can signal to the UE a list of PLMN for which the UE considers those PLMNs in the PLMN list equivalent to its RPLMN. The PLMN equivalent to RPLMN is called EPLMN. The UE that registered with network should be reachable by the network at any time. If the UE is in ECM-CONNECTED (equivalently RRC_CONNECTED), the network is aware of the cell the UE is being served. However, while the UE is in ECM-IDLE (equivalently RRC_IDLE), the context of the UE is not available at the eNB but stored in the MME. In this case, the location of the UE in ECM-IDLE is only known to the MME at the granularity of a list of Tracking Area (TA)s. A single TA is identified by the Tracking Area Identity (TAI) which consists of the PLMN Identity the tracking area belongs to and the Tracking Area Code (TAC) that uniquely represents the TA in the PLMN.

The following description is related to measurement and measurement report.

It is necessary for a mobile communication system to support mobility of a UE. Therefore, the UE persistently measures quality of a serving cell providing a current service and quality of a neighboring cell. The UE reports a measurement result to a network at a proper time. The network provides optimal mobility to the UE by using a handover or the like.

To provide information which can be helpful for a network operation of a service provider in addition to the purpose of supporting the mobility, the UE may perform measurement with a specific purpose determined by the network, and may report the measurement result to the network. For example, the UE receives broadcast information of a specific cell determined by the network. The UE may report to a serving cell a cell identify (also referred to as a global cell identity) of the specific cell, location identification information indicating a location of the specific cell (e.g., a tracking area code), and/or other cell information (e.g., whether it is a member of a closed subscriber group (CSG) cell).

In a state of moving, if the UE determines that quality of a specific region is significantly bad, the UE may report a measurement result and location information on cells with bad quality to the network. The network may attempt to optimize the network on the basis of the measurement result reported from UEs which assist the network operation.

In a mobile communication system having a frequency reuse factor of 1, mobility is generally supported between different cells existing in the same frequency band. Therefore, in order to properly guarantee the UE mobility, the UE has to properly measure cell information and quality of neighboring cells having the same center frequency as a center frequency of a serving cell. Measurement on a cell having the same center frequency as the center frequency of the serving cell is referred to as intra-frequency measurement. The UE performs the intra-frequency measurement and reports a measurement result to the network, so as to achieve the purpose of the measurement result.

A mobile communication service provider may perform a network operation by using a plurality of frequency bands. If a service of a communication system is provided by using the plurality of frequency bands, optimal mobility can be guaranteed to the UE when the UE is able to properly measure cell information and quality of neighboring cells having a different center frequency from the center frequency of the serving cell. Measurement on a cell having the different center frequency from the center frequency of the serving cell is referred to as inter-frequency measurement. The UE has to be able to perform the inter-frequency measurement and report a measurement result to the network.

When the UE supports measurement on a heterogeneous network, measurement on a cell of the heterogeneous network may be performed according to a configuration of a BS. Such a measurement on the heterogeneous network is referred to as inter-radio access technology (RAT) measurement. For example, RAT may include a GMS EDGE radio access network (GERAN) and a UMTS terrestrial radio access network (UTRAN) conforming to the 3GPP standard, and may also include a CDMA 200 system conforming to the 3GPP2 standard.

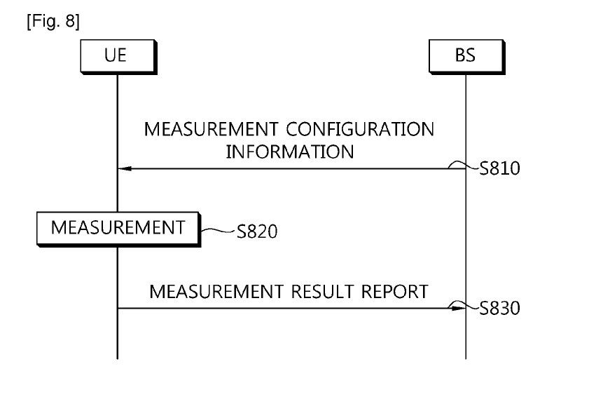

FIG. 8 is a flowchart showing a conventional method of performing measurement.

A UE receives measurement configuration information from a BS (step S810). A message including the measurement configuration information is referred to as a measurement configuration message. The UE performs measurement based on the measurement configuration information (step S820). If a measurement result satisfies a reporting condition included in the measurement configuration information, the UE reports the measurement result to the BS (step S830). A message including the measurement result is referred to as a measurement report message.

The measurement configuration information may include the following information.

(1) Measurement object: The object is on which the UE performs the measurements. The measurement object includes at least one of an intra-frequency measurement object which is an object of intra-frequency measurement, an inter-frequency measurement object which is an object of inter-frequency measurement, and an inter-RAT measurement object which is an object of inter-RAT measurement. For example, the intra-frequency measurement object may indicate a neighboring cell having the same frequency as a frequency of a serving cell, the inter-frequency measurement object may indicate a neighboring cell having a different frequency from a frequency of the serving cell, and the inter-RAT measurement object may indicate a neighboring cell of a different RAT from an RAT of the serving cell.

(2) Reporting configuration: This includes a reporting criterion and a reporting format. The reporting criterion is used to trigger the UE to send a measurement report and can either be periodical or a single event description. The reporting format is a quantity that the UE includes in the measurement report and associated information (e.g. number of cells to report).

(3) Measurement identity: Each measurement identity links one measurement object with one reporting configuration. By configuring multiple measurement identities, it is possible to link more than one measurement object to the same reporting configuration, as well as to link more than one reporting configuration to the same measurement object. The measurement identity is used as a reference number in the measurement report. The measurement identify may be included in the measurement report to indicate a specific measurement object for which the measurement result is obtained and a specific reporting condition according to which the measurement report is triggered.

(4) Quantity configuration: One quantity configuration is configured per RAT type. The quantity configuration defines the measurement quantities and associated filtering used for all event evaluation and related reporting of that measurement type. One filter can be configured per measurement quantity.

(5) Measurement gaps: Measurement gaps are periods that the UE may use to perform measurements when downlink transmission and uplink transmission are not scheduled.

To perform a measurement procedure, the UE has a measurement object, a reporting configuration, and a measurement identity.

In 3GPP LTE, the BS can assign only one measurement object to the UE with respect to one frequency. Events for triggering measurement reporting shown in the table below are defined in the section 5.5.4 of 3GPP TS 36.331 V8.5.0 (2009-03) “Evolved Universal Terrestrial Radio Access (E-UTRA) Radio Resource Control (RRC); Protocol specification (Release 8)”.

TABLE 1

| Events | Reporting Condition |
|---|---|
| Event A1 | Serving becomes better than threshold |
| Event A2 | Serving becomes worse than threshold |
| Event A3 | Neighbor becomes offset better than serving |
| Event A4 | Neighbor becomes better than threshold |
| Event A5 | Serving becomes worse than threshold1 and neighbor |
| | becomes better than threshold2 |
| Event B1 | Inter RAT neighbor becomes better than threshold |
| Event B2 | Serving becomes worse than threshold1 and inter |
| | RAT neighbor becomes better than threshold2 |

If the measurement result of the UE satisfies the determined event, the UE transmits a measurement report message to the BS.

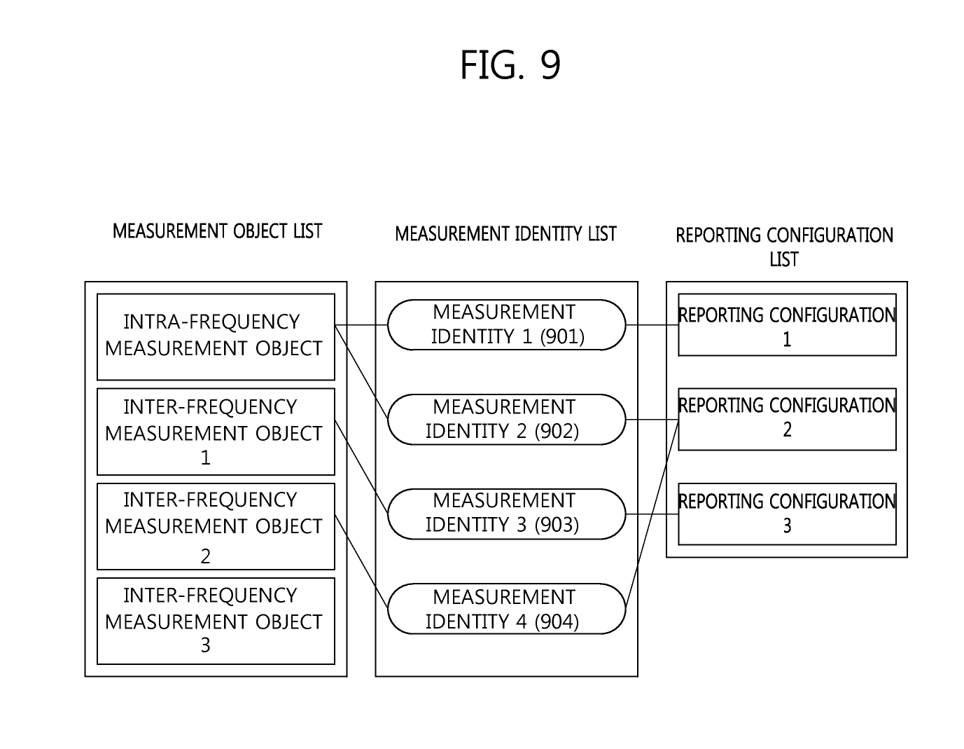

FIG. 9 shows an example of a measurement configuration assigned to a UE.

First, a measurement identity1 901 associates an intra-frequency measurement object with a reporting configuration 1. The UE performs intra-frequency measurement. The reporting configuration 1 is used to determine a reporting type and a criterion for reporting a measurement result.

A measurement identity2 902 is associated with the intra-frequency measurement object similarly to the measurement identifier1 901, and associates the intra-frequency measurement object with a reporting configuration 2. The UE performs intra-frequency measurement. The reporting configuration 2 is used to determine a reporting format and a criterion for reporting a measurement result.

By using the measurement identity1 901 and the measurement identity2 902, the UE transmits a measurement result even if the measurement result on the intra-frequency measurement object satisfies any one of the reporting configuration 1 and the reporting configuration 2.

A measurement identity3 903 associates an inter-frequency measurement object 1 with a reporting configuration 3. When a measurement result on the inter-frequency measurement object 1 satisfies a reporting criterion included in the reporting configuration 1, the UE reports the measurement result.

A measurement identity4 904 associates an inter-frequency measurement object 2 with the reporting configuration 2. When a measurement result on the inter-frequency measurement object 2 satisfies a reporting criterion included in the reporting configuration 2, the UE reports the measurement result.

Meanwhile, the measurement object, the reporting configuration, and/or the measurement identity can be added, modified, and/or deleted. To instruct such operations, the BS may transmit to the UE a new measurement configuration message or a measurement configuration modification message.

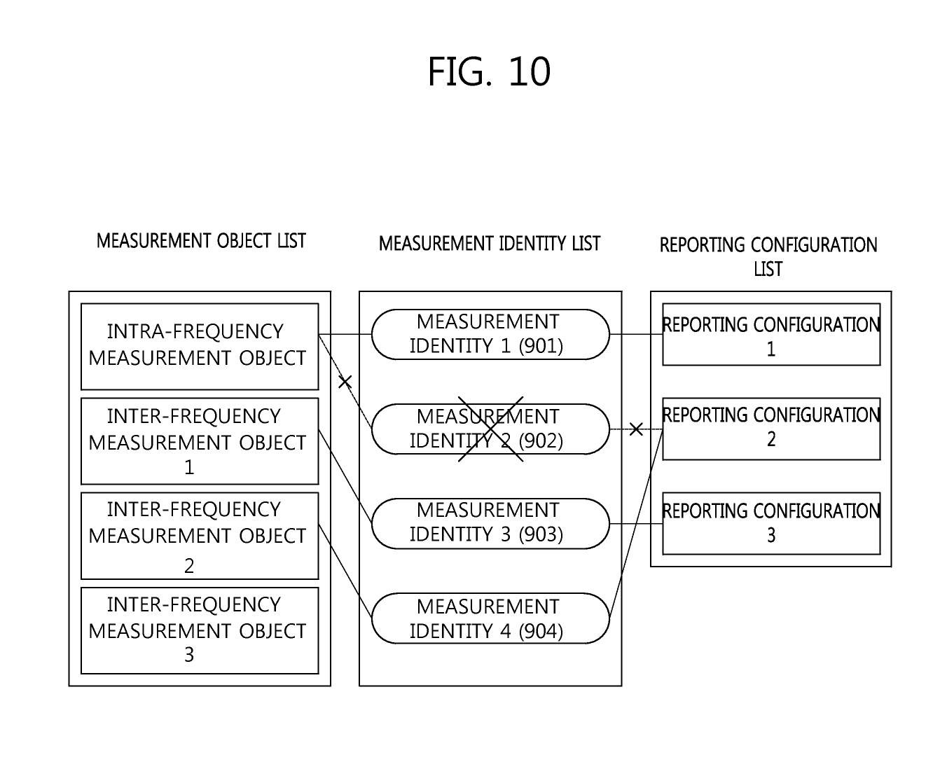

FIG. 10 shows an example of deleting a measurement identity. When a measurement identity2 902 is deleted, measurement on a measurement object associated with the measurement identity2 902 is suspended, and a measurement report is not transmitted. A reporting configuration or a measurement object associated with the deleted measurement identity may not be modified.

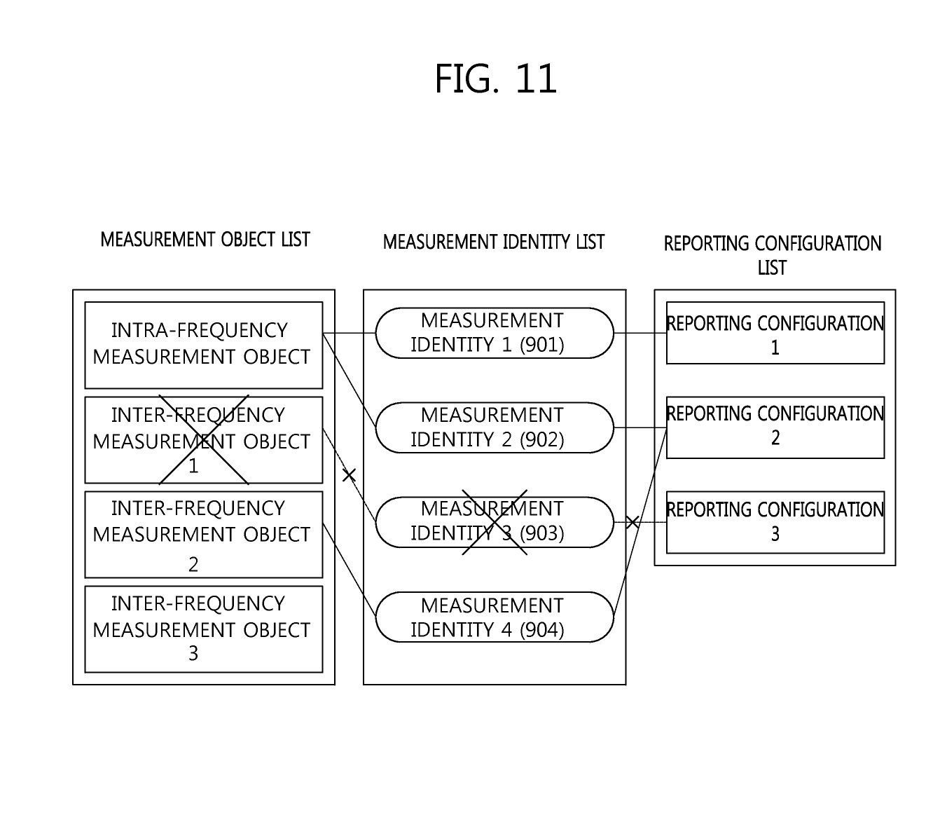

FIG. 11 shows an example of deleting a measurement object. When an inter-frequency measurement object 1 is deleted, a UE also deletes an associated measurement identifier3 903. Measurement on the inter-frequency measurement object 1 is suspended, and a measurement report is not transmitted. However, a reporting configuration associated with the deleted inter-frequency measurement object 1 may not be modified or deleted.

When the reporting configuration is deleted, the UE also deletes an associated measurement identifier. The UE suspends measurement on an associated measurement object according to the associated measurement identifier. Measurement on the measurement object and measurement reporting are suspended. However, a measurement object associated with the deleted reporting configuration may not be modified or deleted.

In a procedure for a cell reselection, a UE selects a target cell for the cell reselection based on priorities of frequencies and requests to establish a RRC connection with the target cell by transmitting a RRC connection request message to the target cell.

Meanwhile, the target cell may be in a situation where the target cell cannot provide a service. For example, when an overload of a frequency of the target cell appears, the target cell cannot provide a normal service. In this case, the target cell may reject the request of the UE, and then the UE may select a proper cell as a new target cell by using the conventional priorities.

The UE which performs the cell reselection by using the conventional priorities may select the target cell which rejected the request for RRC connection establishment of the UE. If a communication circumstance has not changed, the cell is still in the situation where the cell cannot provide the normal service. As a result, the UE repeatedly performs the cell reselection, but cannot receive any service from a network. Therefore, some mechanism to allow network to control reselection operation of the UE is needed in case the request for establishing the RRC connection.

In the present invention, a network provides additional priority information for control the reselection operation of the UE, and the additional priority information is called as ‘supreme priority information’ in below.

Supreme priority information may be implemented in various manners. The information may indicate whether the supreme priority information is applied. When the supreme priority information indicates that the supreme priority is applied, the information further indicates the supreme priority, which is different a normal reselection priority, and the supreme priority may be lower than any other normal priority. The information may indicate whether a deprioritization is applied. That is, the information for deprioritization may further indicate whether the UE applies the lowest priority to a frequency of the cell which transmitted the information or all frequencies of the RAT of the cell. When the information indicates that the deprioritization is applied, the UE applies the lowest priority to a frequency of the cell which transmitted the information or all frequencies of the RAT of the cell, according to the information.

A network signals the supreme priority information to a UE. The information may be transmitted in system information that is broadcasted by a cell. The information may be transmitted in a predetermined message from an eNB to the UE, and the predetermined message may be a RRC message. More particularly, the RRC message may be an RRC connection reject message.

The supreme priority information is applied by the UE only in case of a special situation. And, the UE may determine whether there is a special situation being occurred, by using the event criterion as follows:
If the UE is informed of the overload of current RAT, the UE may consider that special situation has occurred.
If the UE is informed of the overload of current frequency, the UE may consider that special situation has occurred.

Meanwhile, the special situation may be indicated to UE during the RRC connection establishment procedure as follow.
The eNB may include a bit indicating the overload of current RAT in the RRC connection reject message.
The eNB may include a bit indicating the overload of current frequency in the RRC connection reject message.
The eNB may include the supreme priority information in the RRC connection reject message.

When the UE consider that the special situation has occurred, the UE performs a cell reselection procedure based on the supreme priority information. If the supreme priority information indicates the supreme priority is applied, the UE applies the supreme priority instead of the conventional priorities. If the supreme priority information indicates the deprioritization is applied, the UE deprioritizes a current frequency of the cell or all frequencies of the current RAT.

The application of the supreme priority information may be available during predetermined time. After the predetermined time, the UE performs a cell reselection procedure based on normal(original) priorities. For this, the network may further signal a timer related to the predetermined time to the UE. The timer information may be transmitted in the system information with the supreme priority information. The timer information indicates time duration during which the supreme priority information is applied. The timer information may be transmitted may be transmitted in a predetermined message form an eNB to the UE, and the predetermined message may be a RRC message. More particularly, the RRC message may be the RRC connection reject message, and the timer information is transmitted in the message with the supreme priority information.

On receiving the timer information, the UE may start the timer and apply the supreme priority information. If the UE receives additional timer information before expiry of the already received timer, the UE may start or restart the timer. The started timer is set to predetermined time indicated by the additional timer information. The restarted timer is set to a time value of the previous timer.

The timer continues to run when the UE enters RRC_CONNECTED from RRC_IDLE. The timer continues to run when the UE enters RRC_IDLE from RRC_CONNECTED. The timer continues to run when the UE reselects a cell of other RAT that is different from the RAT of a cell from which the timer value was received. The timer continues to run when the UE reselect a cell of the RAT from which the timer value was received, from a cell of the RAT that is different from the RAT from which the timer value was received.

If the UE has reselected the inter-RAT cell by applying the supreme priority information, the UE does not apply the normal priority information that is received in the reselected RAT cell but keeps applying the supreme priority information until the timer is expired. When the timer is expired, the UE applies the normal priority.

In the similar manner, if the UE has reselected inter-frequency cell (intra-RAT cell) by applying the supreme priority information, the UE does not apply normal priority information that is received in cell of the reselected frequency but keeps applying the supreme priority information until the timer is expired. When the timer is expired, the UE applies the normal priority.

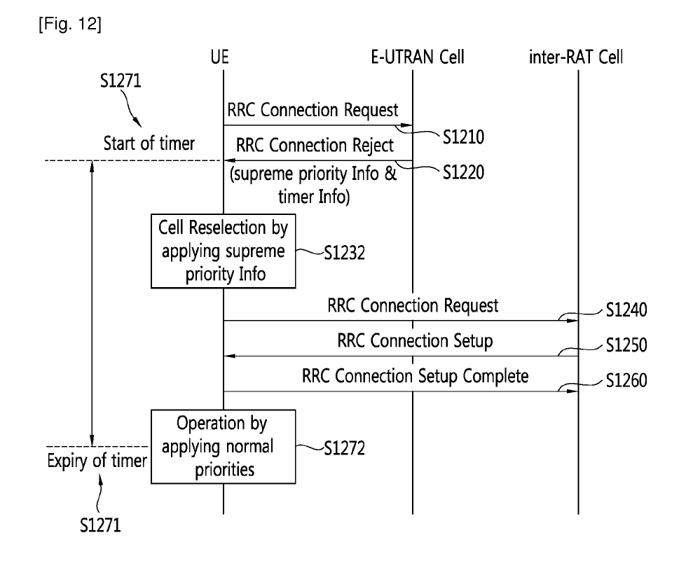

FIG. 12 is a flow chart showing an example of a method of a cell reselection by applying supreme priority according to an embodiment of the present invention.

Referring FIG. 12, a UE transmits an RRC Connection Request message to an E-UTRAN cell for establishing a RRC connection (step S1210).

The E-UTRAN cell transmits RRC connection reject message to the UE (step S1220). The RRC connection reject message may include supreme priority information and timer information.

On receiving the RRC connection request message including the timer information, the UE starts a timer (step S1231). The timer may be set to a predetermined time duration during which the supreme priority information is applied. The predetermined time duration may be indicated by the timer information.

The UE performs a cell reselection by applying the supreme priority information (step S1232). When the supreme priority information indicates a supreme priority lower than a priority of the inter-RAT cell frequencies, the UE applies the supreme priority to the frequencies of the E-UTRAN cell. When the supreme priority information indicates that deprioritization is applied, the UE deprioritizes the priorities of frequencies of the E-UTRAN cell. Therefore, in the cell reselection procedure based on priorities, an inter-RAT cell with the highest frequency may be preferably selected as a target cell.

The UE transmits an RRC connection request message to the selected inter-RAT cell for establishing an RRC connection with the cell (step S1240).

The inter-RAT cell transmits an RRC connection setup message in response to the RRC connection request message (step S1250).

The UE transmits an RRC connection setup complete message to the cell for confirming successful completion of the RRC connection establishment (step S1260).

The UE may maintain the applied supreme priority information after the cell reselection. In other words, the UE enters an RRC_CONNECTED state through the RRC connection establishment procedure, the timer keeps operating and the UE applies the supreme priority information until the expiry of the timer. Furthermore, if the UE returns to an RRC_IDLE state after the RRC connection establishment procedure, the timer keeps operating and the UE applies the supreme priority information.

When the timer is expired (step S1271), the UE stops applying the supreme priority information and operates based on the normal priorities (step S1272).

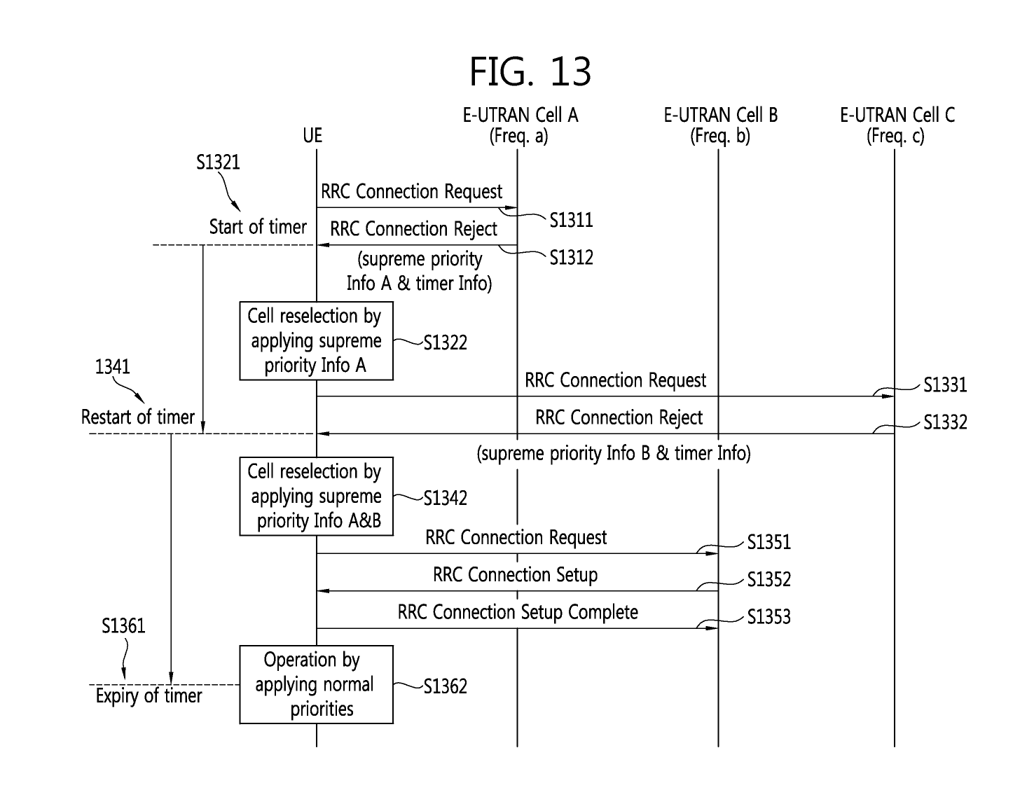

FIG. 13 is a flow chart showing another example of a method of a cell reselection by applying supreme priority according to an embodiment of the present invention. In the example of FIG. 13, it is assumed that a normal priority of frequency ‘a’ is the highest and a normal priority of frequency ‘b’ is the lowest.

Referring to FIG. 13, a UE selects a cell A, which has the highest frequency priority, as a target cell, and transmits an RRC connection request message to the cell A (step S1311).

The cell A transmits an RRC connection reject message to the UE (step S1312). The RRC connection reject message may include supreme priority information A and timer information.

On receiving the RRC connection reject message including the timer information, the UE starts a timer (step S1321). The timer may be set to a predetermined time duration during which the supreme priority information A is applied. The predetermined time duration may be indicated by the timer information.

The UE performs a cell reselection by applying the supreme priority information A (step S1322). When the supreme priority information A indicates that deprioritization for the current frequency is applied, the UE deprioritizes the frequency priority of the cell A.

The UE performs a cell reselection by applying the supreme priority information A and reselects a cell C, which has the highest frequency priority due to the deprioritization of the cell A, as a target cell, and transmits an RRC connection request message to the cell C (step S1331).

The cell C transmits an RRC connection reject message to the UE (step S1332). The RRC connection reject message may include supreme priority information B and timer information.

The UE receives timer information from the cell C before the already operating timer is expired, so that the UE restarts the timer (S1341). The restarted timer is set to same time duration of the previous timer.

Alternatively, the UE receives timer information from the cell C before the already operating timer is expired, so that the UE may start the timer. The newly started timer is set to time duration indicated by the timer information in the RRC connection reject message from the cell C instead of the time duration indicated by the timer information in the RRC connection reject message from the cell A.

The UE performs a cell reselection by applying the supreme priority information A and B (step S1342). The UE deprioritizes the frequency priorities of the cell A and C, and selects a target cell based on frequency priorities.

The UE select a cell B, which has the highest frequency priority due to the deprioritization of the cell A and C, as a target cell, and transmits an RRC connection request message to the cell B (Step S1351).

The cell B transmits an RRC connection setup message in response to the RRC connection request message (step S1352).

The UE transmits an RRC connection setup complete message to the cell B for confirming successful completion of the RRC connection establishment (step S1353).

The UE maintains the applied supreme priority information A and B after the cell reselection. In other words, the UE enters an RRC_CONNECTED state through the RRC connection establishment procedure, the timer keeps operating and the UE applies the supreme priority information until the expiry of the timer. Furthermore, if the UE returns to an RRC_IDLE state after the RRC connection establishment procedure, the timer keeps operating and the UE applies the supreme priority information.

When the timer is expired (step S1361), the UE stops applying the supreme priority information and operates based on the normal priorities (step S1362).

According to the present invention, the application of supreme priority information to a frequency of certain cell or all frequencies of a certain RAT to which a UE is not allowed to connect prevents the UE from repeatedly performing a cell reselection and/or an RRC connection establishment procedure with the same cell which has rejected a request of the UE. The UE can select a proper target cell by applying the supreme priority and quickly establish an RRC connection with the target cell. Therefore, a quality of service provided to the UE can be enhanced.

According to the present invention, a timer for the supreme priority information is provided. During the operation of the timer, the UE applies the supreme priority information. The operation of the timer prevents the UE from returning to the cell which rejected a request of the UE after the cell reselection procedure. Therefore, by using the timer, a stable service for the UE can be provided.

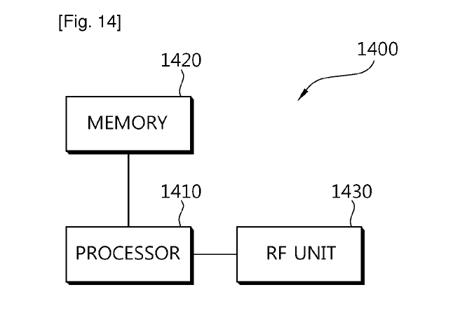

FIG. 14 is a block diagram showing a wireless apparatus according to an embodiment of the present invention. The apparatus implements an operation of a UE and/or a BS according to the embodiments of FIGS. 12 and 13.

A wireless apparatus 1400 includes a processor 1410, a memory 1420, and a radio frequency (RF) unit 1430. The processor 1410 implements the proposed functions, procedures, and/or methods. The processor 1410 may be configured to receive supreme priority information and/or timer information. The processor 1410 may be configured to determine whether the deprioritization is applied and deprioritize a frequency or all frequencies of a RAT. The processor 1410 may be configured to start a timer indicated by the timer information. The processor 1410 may be configured to perform a cell reselection based on the applied deprioritization and the timer. The embodiments of FIGS. 12 and 13 can be implemented by the processor 1410 and the memory 1420.

The RF unit 1430 coupled to the processor 1410 transmits and receives a radio signal.

The processor may include an application-specific integrated circuit (ASIC), a separate chipset, a logic circuit, and/or a data processing unit. The memory may include a read-only memory (ROM), a random access memory (RAM), a flash memory, a memory card, a storage medium, and/or other equivalent storage devices. The RF unit may include a base-band circuit for processing a radio signal. When the embodiment of the present invention is implemented in software, the aforementioned methods can be implemented with a module (i.e., process, function, etc.) for performing the aforementioned functions. The module may be stored in the memory and may be performed by the processor. The memory may be located inside or outside the processor, and may be coupled to the processor by using various well-known means.

Although the aforementioned exemplary system has been described on the basis of a flowchart in which steps or blocks are listed in sequence, the steps of the present invention are not limited to a certain order. Therefore, a certain step may be performed in a different step or in a different order or concurrently with respect to that described above. Further, it will be understood by those ordinary skilled in the art that the steps of the flowcharts are not exclusive. Rather, another step may be included therein or one or more steps may be deleted within the scope of the present invention.

1. A method of a cell reselection in a wireless communication system, the method comprising:
receiving, by a user equipment (UE), supreme priority information from a target cell, the supreme priority information indicating whether a deprioritization is applied;
applying, by the UE, the supreme priority information, if the supreme priority information indicates that the deprioritization is applied; and
performing, by the UE, a cell reselection based on the applied deprioritization.

2. The method of claim 1,
wherein the supreme priority information is transmitted in an RRC connection reject message

3. The method of claim 2,
wherein the step of applying the supreme priority comprises:
deprioritizing a priority of a frequency of the target cell by considering the frequency to be the lowest priority frequency.

4. The method of claim 2,
wherein the step of applying the supreme priority comprises:
deprioritizing priorities of all frequencies of a Radio Access Technology of the target cell by considering the frequencies to be the lowest priority frequency.

5. The method of claim 1
wherein the RRC connection reject message further comprises timer information indicating a time duration for which the deprioritization is applied.

6. The method of claim 5, further comprising:
starting, by the UE, a timer set to the time duration indicated by the timer information.

7. The method of claim 6, further comprising:
canceling, by the UE, the deprioritization when the timer is expired.

8. The method of claim 6, further comprising:
receiving, by the UE, an RRC connection reject message from other target cell, the RRC connection reject message comprising the timer information; and
restarting, by the UE, the timer.

9. The method of claim 6, further comprising:
establishing, by the UE, an RRC connection with a cell,
wherein the started timer keeps operating after the establishment until the end of the time duration.

10. The method of claim 6, further comprising:
entering, by the UE, an RRC connected state,
wherein the started timer keeps operating after the entry of the UE until the end of the time duration.

11. A wireless apparatus in a wireless communication system comprising:
a Radio Frequency (RF) unit transmitting and receiving radio signals; and
a processor operably coupled to the RF unit, wherein the processor is configured for:
receiving supreme priority information from a target cell, the supreme priority information indicating whether a deprioritization is applied,
applying the supreme priority information, if the supreme priority information indicates that the deprioritization is applied, and
performing a cell reselection based on the applied deprioritization.

12. The wireless apparatus of claim 11,
wherein the supreme priority information is transmitted in an RRC connection reject message

13. The wireless apparatus of claim 12,
wherein the applying the supreme priority comprises:
deprioritizing a priority of a frequency of the target cell by considering the frequency to be the lowest priority frequency.

14. The wireless apparatus of claim 12,
wherein the applying the supreme priority comprises:
deprioritizing priorities of all frequencies of a Radio Access Technology of the target cell by considering the frequencies to be the lowest priority frequency.

15. The wireless apparatus of claim 11,
wherein the RRC connection reject message further comprises timer information indicating a time duration for which the deprioritization is applied.

16. The wireless apparatus of claim 15, wherein the processor is further configured for:
starting a timer set to the time duration indicated by the timer information.

17. The wireless apparatus of claim 16, wherein the processor is further configured for:
canceling the deprioritization when the timer is expired.

18. The wireless apparatus of claim 16, wherein the processor is further configured for:
receiving an RRC connection reject message from other target cell, the RRC connection reject message comprising the timer information, and restarting the timer.

19. The wireless apparatus of claim 16, wherein the processor is further configured for:
establishing an RRC connection with a cell,
wherein the started timer keeps operating after the establishment until the end of the time duration.

20. The wireless apparatus of claim 16, wherein the processor is further configured for:
entering an RRC connected state,
wherein the started timer keeps operating after the entry of the wireless apparatus until the end of the time duration.
